(19) United States
(12) Patent Application Publication
(10) Pub. No.: US 2020/0313432 A1
(43) Pub. Date: Oct. 1, 2020

(54) ENERGY MANAGEMENT SYSTEM OF SUNLIGHT/ESS DEVICE FOR TRACKING GENERATION REFERENCE AND METHOD OF CONTROLLING THE SAME

(71) Applicant: DIK Co., Ltd., Gangwon-do (KR)

(72) Inventors: Byung Kwan KANG, Seoul (KR); Seoung Uk JEON, Gangwon-do (KR)

(21) Appl. No.: 16/309,696

(22) PCT Filed: Dec. 5, 2017
(86) PCT No.: PCT/KR2017/014143

§ 371 Date: Dec. 13, 2018

(30) Foreign Application Priority Data
Nov. 28, 2017 (KR) 10-2017-0160189

(51) Int. Cl. H02J 3/00; H02J 3/38; H02J 3/32; G06Q 50/06

(52) U.S. Cl. CPC H02J 3/008; H02J 3/381; H02J 2300/24; G06Q 50/06; H02J 3/32

(57) ABSTRACT

Provided are an energy management system of a sunlight/ESS device for tracking a generation reference and a method of controlling the same, for further increasing a lifespan of a battery and well as earning revenue of a power producer by tracking predicted generation information, charging an ESS, and selling the power during production and selling of power from the sunlight/ESS device.

### TECHNICAL FIELD

The present invention relates to an energy management system of a grid-connected sunlight/energy storage system (ESS) device, and more particularly, to an energy management system of a sunlight/ESS device that tracks a generation reference and a method of controlling the energy management system, for increasing a lifespan of a battery and maximizing profit from charging and selling power produced by a renewable energy source.

### BACKGROUND ART

In general, an energy storage system (ESS) is a storage apparatus for storing excess power produced by an electric power station or irregularly produced renewable energy and transmitting the power or the energy during temporary periods of insufficient power.

In detail, an ESS refers to a system for storing electricity in an electric power system in order to supply energy at a required time in a required place. In other words, the ESS is one assembly including storage obtained by integrally configuring systems in a single product, like a conventional secondary battery.

Recently, an ESS has become important as a required apparatus that stores electric energy generated in an unstable manner during radiation of sunlight, which is a source of renewable energy, and stably re-supplies the electric energy to a power system. When there is no ESS, serious problems such as sudden blackout of a power system due to instability of power supply dependent upon wind or sunlight may arise. Accordingly, storage has become a very important field in such environments.

Such an ESS is installed and used in electricity generation, power transmission and distribution, and additionally by consumers using a power system, and performs functions such as frequency regulation, generator output stabilization using renewable energy, peak shaving, load leveling, and provision of an emergency power source.

An ESS is broadly classified into physical energy storage and chemical energy storage according to the storage method. Physical energy storage is a method using pumping-up power generation, compressive air storage, a flywheel, or the like, and chemical energy storage is a method using a lithium ion battery, a lead storage battery, a NaS battery, or the like.

Recently, the government plans to assign a renewable energy certificate (REC) weight of 5.0 when an ESS is connected to sunlight in addition to wind power in order to activate the ESS.

The Ministry of Trade, Industry and Energy also plans to apply a policy of assigning a relatively high REC weight to wind-power equipment connected to an ESS and has amended RPS manufacture management/operation rules to assign an REC weight of 5.0 to sunlight equipment in which an ESS is installed in order to supply electricity.

However, such a renewable energy certificate (REC) weight of 5.0 is a method of generating renewable energy, performing charging between 10:00 and 16:00 and discharging after 18:00 in order to supply solar power. Battery discharge capacity efficiency is not considered, and thus a power value is assigned without consideration of energy loss in an existing battery-charging scenario. As a result, a large amount of power is forcedly assigned to a battery in the early stage of charging, and then power is sold without subsequent participation in charging.

Conventionally, when a PV/ESS is designed in order to maximum the capacity of the installed PV/ESS, greater capacity than is required is typically selected, leading to budget overruns, and thus a PV/ESS business operator forecasts an average generated power amount per year and selects an ESS capacity based on the most frequently generated amount of power. Accordingly, in the prior art, the entire amount of generated power is charged in the ESS on a day when a generated power amount is greater than average, and after charging is completed in the ESS, the power produced through a PV is sold without weighted pricing. Thus, energy is managed without consideration of capacity efficiency, and thus the amount of stored energy is low and the lifespan of a battery is also adversely affected.

FIG. 1 is a graph showing a battery discharge capacity relationship depending upon a number of charge and discharge cycles in a general ESS.

As shown in FIG. 1, efficiency of participation in a chemical reaction during charging/discharging with high power in a battery is not 100%, and thus, slightly less charging is performed and slightly more discharging is performed. When the charged and discharged power is higher than a battery discharge capacity, the speed of a chemical reaction in a battery is relatively low, and thus more chemical materials participate in the reaction.

Accordingly, the reaction is terminated before the maximum possible amount of electrical energy is charged, and thus, discharge capacity efficiency is lowered. This phenomenon becomes more serious as the power amplitude is greater than the discharge capacity and adversely affects the lifetime of the battery as well as the available capacity of the battery.

### DISCLOSURE

### Technical Problem

An object of the present invention devised to solve the problem lies in an energy management system of a sunlight/ESS device that tracks a generation reference and a method of controlling the energy management system, for further increasing a lifespan of a battery and well as earning revenue of a power producer by tracking predicted generation information, charging an ESS, and selling the power in a situation in which power is produced by the sunlight/ESS device and is sold.

### Technical Solution

The object of the present invention can be achieved by providing an energy management system of a sunlight/energy storage system (ESS) device for tracking a generation reference, the energy management system including a sunlight generation unit for producing electric energy from sunlight, a power converter for converting electric energy produced by the sunlight generation unit into alternating current (AC) power and outputting the AC power, a PCS for receiving the AC power converted by the power converter, converting the AC power into direct current (DC) power, and outputting the DC power, an ESS for receiving and storing the DC power converted by the PCS, a Korea electric power system for buying the AC current converted through the PCS from the AC power converted by the power converter or the DC power stored in the ESS, a load for receiving and using the AC power sold to the Korea electric power system, and an energy management system (EMS) for receiving generation information of the sunlight generation unit, storage information of the ESS, and system information of the load, controlling power of the power converter and the PCS to control a charge amount of the ESS, and controlling a power amount sold to the Korea electric power system.

In another aspect of the present invention, provided herein is a method of controlling an energy management system of a sunlight/energy storage system (ESS) device for tracking a generation reference, the method including recognizing generation information of a sunlight generation unit, charging information of an ESS, and system information of a load, determining whether a current time is a charging time, selling charged power of the ESS to Korea electric power system when the current time is not the charging time, analyzing, optimizing, and calculating the generation information of the sunlight generation unit, the charging information of the ESS, and the system information of the load when the current time is the charging time, determining whether a power selling amount sold without a weight via optimization and calculation is greater or smaller than a reference value via comparison therebetween, selling a portion of power generated by the sunlight generation unit to the Korea electric power system and also charging the ESS when the power selling amount sold without a weight is greater than the reference value, and charging generated power produced by the sunlight generation unit in the ESS when the power selling amount sold without a weight is less than the reference value. Advantageous Effects

An energy management system of a sunlight/energy storage system (ESS) device for tracking a generation reference and a method of controlling the energy management system according to an embodiment of the present invention may have the following effects.

First, the losses to be borne by a PV/ESS business operator may be minimized in order to maximize profit according to REC 5.0 with an efficient energy management system (EMS).

Second, an amount of energy that is used in charging and discharging may be increased by increasing the capacity efficiency of an ESS. That is, when a loss is applied during calculation, even if charging is performed at the same time, a power amount may be prevented from being unbalanced and charging may be performed in consideration of the lifespan and safety of a battery, thereby increasing the lifespan of a battery and saving energy.

Third, the remaining amount of power may be sold in real time in order to increase profit of power selling through a method of tracking information on a solar radiation quantity, etc.

Fourth, the energy management system may be usefully applied in power distribution of a battery of other systems using a battery as well as a PV/ESS device and may increase the available energy amount and the lifespan of the battery, thereby overcoming an environmental problem and reducing costs for users of a renewable energy source.

Fifth, the energy management system may be usefully applied in a simulation for embodying a system using a battery, a battery management system, or the like, environmental problems due to use of electricity may be solved, and costs borne by users of a renewable energy source may be reduced.

### DESCRIPTION OF DRAWINGS

FIG. 1 is a graph showing a battery discharge capacity relationship depending upon a number of charge and discharge cycles in a general electric storage system (ESS).

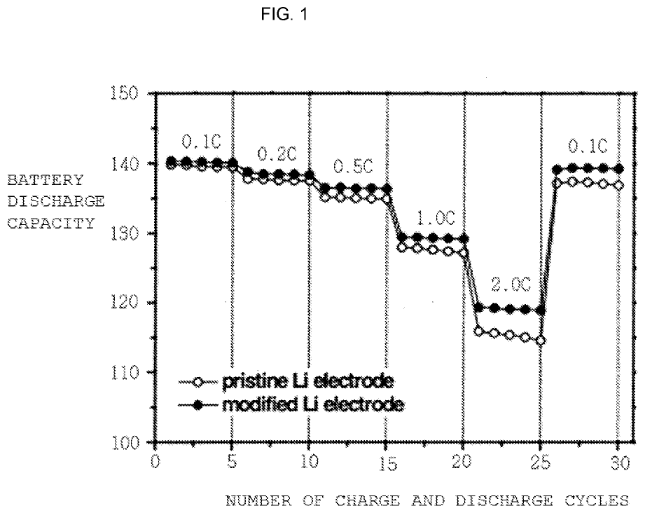

FIG. 2 is a schematic diagram showing a configuration of power flow depending on charging and discharging in a sunlight/energy storage system (ESS) device tracking a generation reference according the present invention.

FIG. 3 is a schematic block diagram of an energy management system of a sunlight/ESS device that tracks a generation reference according to the present invention.

FIG. 4 is a circuit diagram showing the power converter of FIG. 3 in detail.

FIG. 5 is a flowchart showing a method of controlling an energy management system of a sunlight/ESS device for tracking a generation reference according to the present invention.

FIG. 6 is a graph showing a relationship between a reference generation amount and an actual generation amount of the sunlight generation unit of FIG. 2.

FIGS. 7 and 8 are graphs showing the assignment of charged power of an ESS via appropriate distribution of a reference generation amount and actually generated power using an energy management system (EMS).

### BEST MODE

Hereinafter, at least one embodiment of the present disclosure will be described in detail with reference to the accompanying drawings. However, in the following description of the at least one embodiment, a detailed description of known functions and configurations incorporated herein will be omitted for clarity and brevity. In the following description, like reference numerals designate like elements although the elements are shown in different drawings.

The terms and words which are used in the present specification and the appended claims should not be construed as being confined to common meanings or dictionary meanings but should be construed as meanings and concepts matching the technical spirit of the present invention in order to describe the present invention in the best fashion. Accordingly, the embodiments stated in the specification and the components shown in the drawings are merely an exemplary embodiment of the present invention and are not intended to represent all technical ideas of the present invention, and thus, it is to be appreciated that all equivalents and changes that do not depart from the spirit and technical scope of the present invention are encompassed in the present invention when the application is filed.

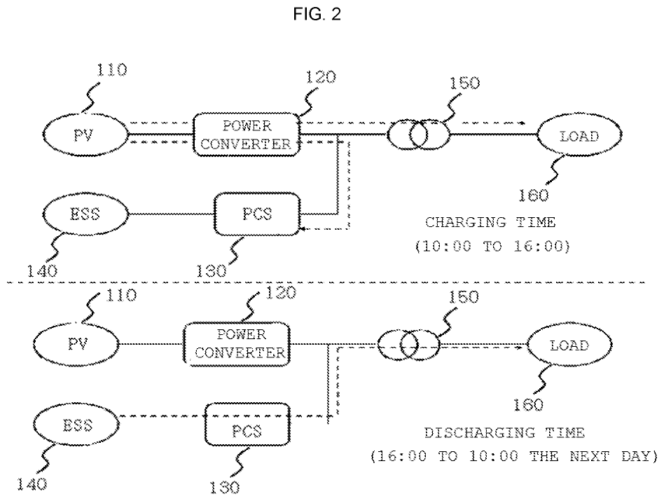

FIG. 2 is a schematic diagram showing the configuration of power flow depending on charging and discharging in a sunlight/energy storage system (ESS) device tracking a generation reference according the present invention.

As shown in FIG. 2, power produced by a sunlight generation unit 110 may be converted by a power converter 120 to be sold to Korea electric power system 150 and to be simultaneously charged in an ESS 140 through a PCS 130.

In this case, charging of the ESS 140 and selling of the Korea electric power system 150 may be performed between 10:00 and 16:00 and selling of power charged in the ESS 140 may be performed between 16:00 and 10:00 the next day.

According to the present invention, current flow during charging and discharging is indicated by the dotted lines, and selling and charging are simultaneously performed depending on the amount of power generated by the sunlight generation unit 110.

The present invention proposes an optimum energy management system (EMS) that applies generation information, storage information, and various factors to be considered and tracks predicted generation information to charge the ESS in a situation in which a PV/ESS business operator produces and sells power from a renewable energy source including the sunlight generation unit 110.

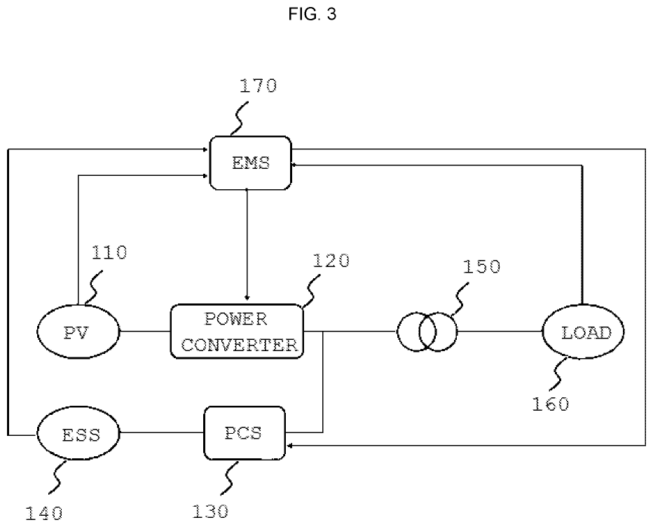

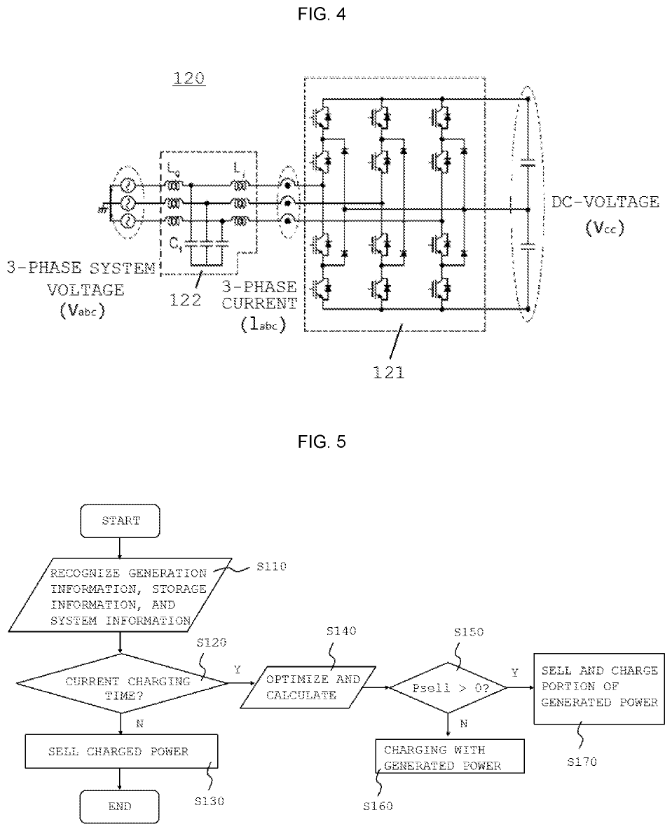

FIG. 3 is a schematic block diagram of an energy management system of a sunlight/ESS device that tracks a generation reference according to the present invention. FIG. 4 is a circuit diagram showing the power converter of FIG. 3 in detail.

As shown in FIG. 3, the energy management system of the sunlight/ESS device that tracks a generation reference according to the present invention may include the sunlight generation unit 110 for producing electric energy from sunlight, the power converter 120 for converting electric energy produced by the sunlight generation unit 110 into alternating current (AC) power and outputting the AC power, the PCS 130 for receiving the AC power converted by the power converter 120, converting the AC power into direct current (DC) power, and outputting the DC power, an ESS 140 for receiving and storing the DC power converted by the PCS 130, the Korea electric power system 150 for buying the AC current converted through the PCS 130 from the AC power converted by the power converter 120 or the DC power stored in the ESS 140, a load 160 for receiving and using the AC power sold to the Korea electric power system 150, and an energy management system (EMS) 170 that receives generation information of the sunlight generation unit 110, storage information of the ESS 140, and system information of the load 160, controls power of the power converter 120 and the PCS 130 to control a charge amount of the ESS 140, and controls a power amount sold to the Korea electric power system 150.

Here, the sunlight generation unit 110 may include a plurality of solar energy sources and, in this state, may convert sunlight energy into electric energy to generate DC power.

The solar cell may collect sunlight emitted from the outside to generate electricity, and generally, may be mainly formed of silicon and composite materials. In detail, the solar cell may be used in a junction of a P-type semiconductor and an N-type semiconductor and uses the photoelectric effect of receiving sunlight to produce electricity. Most solar cells may include a large-area P-N junction diode, and electromotive force generated at opposite ends of the P-N junction diode may be connected to an external circuit and may be used.

A minimum unit of the solar cell is referred to as a cell, and in reality, a solar cell is barely used as a cell without change. The required voltage for actual use is several volts to several tens or several hundreds of volts, but a voltage from one cell is a very small value of about 0.5 V, and thus a plurality of unit sunlight arrays may be connected and used in series or in parallel in order to satisfy a required unit capacity. In addition, when a solar cell is used outdoors, the solar cell is placed in various severe environments, and thus a plurality of cells is configured and used as a package in order to protect a plurality of cells connected to satisfy a required unit capacity from a severe environment.

A connection box for collecting voltages of the same polarity output from respective solar cells may be disposed downstream of the solar cells

As shown in FIG. 4, the power converter 120 may include a plurality of switching devices 121 and a grid-connected filter 122.

The plurality of switching devices 121 may convert the DC voltage input from the DC voltage into an AC voltage via conversion in an on or off state based on a pulse width modulation (PWM) signal for controlling the power converter 120.

The grid-connected filter 122 may include a power converter, system-side inductors Li and Lg, and a filter capacitor Cf. That is, the grid-connected filter 122 may be embodied as an LCL filter. Alternatively, the grid-connected filter 122 may be embodied as an LC filter.

Here, the LCL filter may be represented by the power converter and system-side inductors Li and Lg and the filter capacitor Cf. When the LCL filter is used, a resonance phenomenon occurs due to L and C and a resonant band is formed around a resonant frequency.

The PCS 130 may convert the DC power produced by the sunlight generation unit 110 into AC power through the power converter 120 and may re-convert the AC power into DC power to store the DC power in the ESS 140. In addition, the PCS 130 may convert the DC power stored in the ESS 140 into AC power and may supply the AC power to the Korea electric power system 150.

Here, the EMS 170 may acquire the generation information of the sunlight generation unit 110, may synchronize the charging time of the ESS 140, and may also calculate an amount of current to be sold to the one system 150.

The storage information of the ESS 140 may be information on the type and charging time of the battery, the capacity efficiency of which is changed depending on the power amount during charging/discharging. In more detail, the storage information of the ESS 140 may refer to load capacity, and may be information on the amount of stored rectified current or a current charging amount.

The system information of the load 160 may be information on the amount of current that is currently being used by the load 160.

The present invention proposes an optimum EMS 170 that takes into account generation information, storage information, and system information and tracks predicted generation information to charge the ESS 140 in the situation in which a PV/ESS business operator produces and sells power.

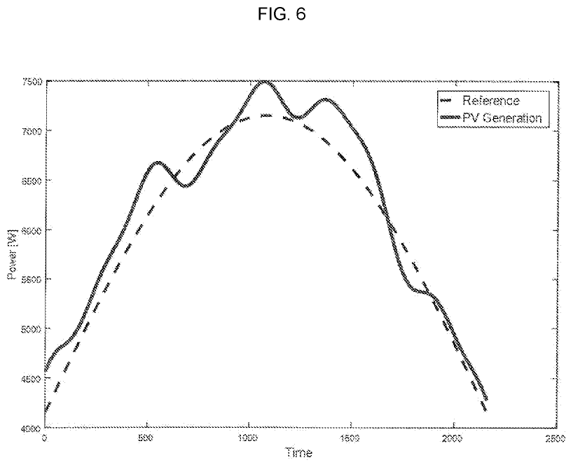

FIG. 5 is a flowchart showing a method of controlling an energy management system of a sunlight/ESS device for tracking a generation reference according to the present invention.

As shown in FIG. 5, the method of controlling an energy management system of a sunlight/ESS device for tracking a generation reference according to the present invention may include recognizing the generation information of the sunlight generation unit 110, the storage information of the ESS, and the system information of the load (S110).

Here, the sunlight generation unit 110 may have a difference between a reference generation amount and an actual generation amount depending on the installation area, the temperature, and the weather. That is, the pattern of the generation amount generated by the sunlight generation unit 110 is different every day, and thus the generation information, the storage information, and the system information may be transmitted to the EMS in real time, and the EMS 170 may recognize the received information.

Then, whether the current time is a charging time may be determined (S120).

Here, as described above, the charging time may be calculated based on the generation information generated from the sunlight generation unit 110 between 10:00 and 16:00, and a discharging time, i.e., a selling time for selling power stored in the ESS to one system, may be between 16:00 and 10:00.

Then, when the current time is not the charging time, the power charged in the ESS 140 may be sold to one system (S130).

That is, at the time point in which the sunlight generation unit 110 does not generate electricity, the power stored in the ESS 140 may be sold to the one system 150 in order to supply power to required loads, and a PV/ESS business operator may earn revenue through the power sold to the one system 150.

Then, when the current time is the charging time, the generation information of the sunlight generation unit 110, the charging information of the ESS 140, and the system information of the load 160 may be analyzed, optimized, and calculated (S140).

Here, optimization and calculation through the EMS 170 will be described below in more detail, and a portion of the power generated by the sunlight generation unit through the EMS 170 may be sold to the one system 150 and may also be charged in the ESS 140.

Then, whether a power-selling amount Psell sold without a weight via optimization and calculation is greater or smaller than a reference value ‘0’ may be determined via comparison therebetween (S150).

Here, the selling amount Psell sold without a weight may be calculated based on the difference between an actual generation amount Pgen generated from the sunlight generation unit 110 and a power-charging amount Pess charged in the ESS 140.

Then, when the power-selling amount sold without a weight is greater than the reference value, a portion of the power generated by the sunlight generation unit 110 may be sold to the one system 150 and may also be charged in the ESS 140 (S160).

When the power selling amount sold without a weight is smaller than the reference value, generated power produced by the sunlight generation unit 110 may be charged in the ESS 140 (S170).

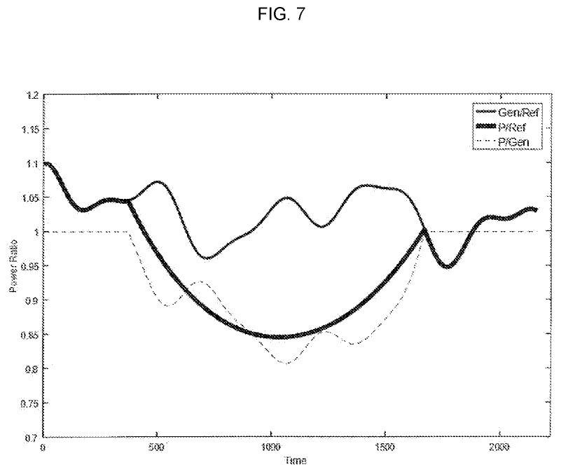

FIG. 6 is a graph showing the relationship between a reference generation amount and an actual generation amount of the sunlight generation unit of FIG. 2.

As shown in FIG. 6, the sunlight generation unit 110 may have a greater actual generation amount than a reference generation amount, which differs depending on a temperature and the weather. In this case, according to the present invention, the EMS 170 that receives the generation information of the sunlight generation unit 110 may adjust the charging amount to perform charging for each predetermined time zone rather than rapidly performing charging of the ESS 140 depending on the generation amount of the sunlight generation unit 110 while viewing the generation information between 10:00 and 16:00, and thus may increase the available capacity of the ESS 140 and may further increase the lifespan thereof.

When the amount of electricity generated by the sunlight generation unit 110 is greater than a reference generation amount, the EMS 140 may control charging of the ESS 140, and simultaneously, may arbitrarily adjust a selling time and an amount of power sold to the one system 150, and may sell power after 16:00, thereby earning revenue with a weight of 5.0.

The sunlight generation unit 110 may have a difference between a reference generation amount and an actual generation amount that is changed depending on a change in location, season, and weather of an installation area as well as the temperature and the weather. That is, the pattern of the actual amount of electricity generated by the sunlight generation unit 110 is different every day, and thus, according to the present invention, the EMS 170 may analyze the generation information and may arbitrarily adjust the charging amount of the ESS 140 and the amount sold to the one system 150 to prolong the lifespan of the battery and to also effectively earn revenue by selling power.

To this end, the EMS 170 may determine charging of the ESS 140 and a selling amount to the Korea electric power system 150 according to Expression 1 below.

min{ω₁·C₁·P_{cap.loss}+ω₂·C₂·Pₛₑₗₗ+ω₃·(∫Pₑₓₚ−∫Pₑₛₛ)²} Expression 1

Here, PPₑₛₛ≤P_{gen}

Table 1 below is for explanation of parameters of Expression 1 above.

TABLE 1
Explanation of parameter

| | | | | | |
|---|---|---|---|---|---|
| 1 | objective | 1 | Price of electric | P_{cap.loss} | Power loss occurring |
| | function | | energy sold with | | due to capacity |
| | weight 1 | | weight of 5 | | efficiency |
| 2 | objective | 2 | Price of electric | Pₛₑₗₗ | Amount of power sold |
| | function | | energy sold at first | | without weight |
| | weight 2 | | cost without weight | | Pₛₑₗₗ = P_{gen} − Pₑₛₛ |
| 3 | objective | exp | Power reference for | P_{gen} | Generated power amount |
| | function | | charging power | Pₑₛₛ | Battery charging power |
| | weight 3 | | generated for six | | amount |
| | | | hours according to | | |
| | | | capacity of battery | | |

Here, the weight w1 of an objective function may apply a weight of 5 depending on the market price to power (energy) that is not capable of being used due to power loss based on capacity efficiency of the ESS 140. Accordingly, a loss of money in the case of sale of a power producer may be minimized, which may occur if power is charged without consideration of capacity efficiency of the ESS 140.

A power loss Pcap.loss occurring due to capacity efficiency of an ESS (battery) may be represented according to Expression 2 below.

$${P}_{cap . loss} = {P}_{ess} \cdot ( 1 - {η}_{cap . loss} ) \\ {η}_{cap . loss} = - {κ ( \frac{{P}_{ess}}{{P}_{rate}} )}^{3} + 1 \qquad Expression 2$$

Power loss Pcap.loss occuring due to capacity efficiency of the ESS (battery), indicating that the extend of loss is increased as power is increased as represented in Expression 2 above, may be applied to η_{cap.loss} change an inclination to k due to the different capacity characteristics of each battery of an ESS.

The weight w2 of an objective function may reduce the amount sold in real time to the one system 150 without a weight rather than charging the ESS 140 with a portion of the electricity generated by the sunlight generation unit 110. It makes economic sense to lower the power of the ESS 140 to reduce the loss attributable to capacity efficiency, but it makes more economic sense to store power in the ESS 140 and then to sell the power after 16:00, and it does not make economic sense to sell power in real time, and thus selling in real time may be minimized and a selling amount may be adjusted using a weight w2 rather than unconditionally tracking a generation amount.

In addition, weight w3 of an objective function applies a solar radiation quantity from which the charging amount of a battery is predicted. The EMS 170 may adjust a charging amount of the ESS 140 to appropriately distribute power for 6 hours, in which power is applied but is charged in real time. (∫Pₑₓₚ−∫Pₑₛₛ)² may be used with a weight applied thereto to distribute charged power depending on the weather.

The sunlight generation unit 110 may make a generation amount to be charged for each time zone depending on the capacity of the ESS 140 as Pexp and may apply Pexp under the control of the EMS 170 during generation for 6 hours between 10:00 and 16:00. This is an example of a generation pattern of the sunlight generation unit 110, and charging and selling may be performed under the control of the EMS 170 at any place in which a PV/ESS device is installed.

In this case, when Pexp is not present, the PV/ESS device may unconditionally assign a generation amount to charging of the ESS 140. However, not all generation amounts may be assigned to charged power, and power may be charged in consideration of the generation situation with a reference function Pexp for assigning and distributing charged power for each time zone. A generation amount pattern may be input as a reference to an objective function in a cumulative manner, and the EMS 170 may estimate the generation amount and may supply power to the ESS 140.

An objective function is set to ensure convexity of power Pess to be distributed in the form of a quaternary and primary, and primary integration function, and thus a global solution may be provided to solve the problem of optimization.

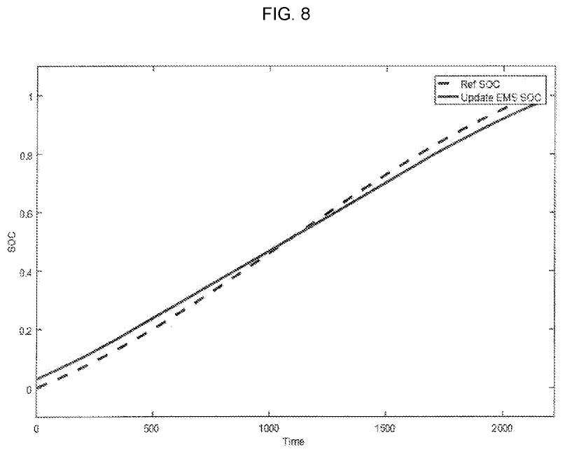

FIGS. 7 and 8 are graphs showing the assignment of charged power of an ESS via appropriate distribution of a reference generation amount and actually generated power using an EMS.

As seen in FIG. 7, the blue plot indicates the ratio of the actually generated amount to the reference Pexp, and in this case, when the ratio is greater than 1, a large amount of power is generated, and when the ratio is less than 1, a smaller amount of power than expected is generated.

It may be seen that the red plot indicates the ratio of a power value assigned to an ESS to a charging reference Pexp and that about 10 to 15% of a generation amount between 10:00 and 12:00, during which time a generation amount is low, and between 12:00 and 2:00, during which time a generation amount is particularly high, is sold without a weight rather than being assigned to charging of the ESS 140.

It may be seen in FIG. 8 that the power charged in the ESS 140 may similarly track a reference to be assigned up to a target value.

Accordingly, according to the present invention, when a generation amount of the sunlight generation unit 110 is greater than expected, less than 100% of the power may be charged in the ESS 140, and a portion of the power may be sold through the one system 150.

However, when the amount of electricity generated by the sunlight generation unit 110 is low or the weather changes, the EMS 170 may be rationally operated. When the generation amount is lowered, w1 and w2 may be relatively reduced and w3 may have a continuously increasing difference in energy accumulation amount and, thus, the greater portion of the objective function may be occupied by w3, and as a result, all generation amounts may be assigned to the ESS 140.

The EMS 170 is applied in real time, and thus, a function Pexp may be corrected during generation to change a plan about charging of the ESS 140 and power assignment of the Korea electric power system 150.

A weight of 5, depending on the market price, may be applied to power (energy) that is not capable of being used due to power loss by a user. Accordingly, a loss of money in the case of sale of a power producer may be minimized, which may occur if power is charged without consideration of capacity efficiency of the ESS 140.

The exemplary embodiments of the present invention may include a computer readable medium including a program command for performing an operation executed by various computers. The computer readable medium may include a program command, a local data file, a locate data structure, or the like alone or in a combination thereof. The medium may be particularly designed and configured for the present invention, but may be known and used in those of ordinary skill in the art of computer software.

Examples of a computer readable recording medium include magnetic media such as hard disks, floppy disks and magnetic tapes, optical media such as CD-ROMs and DVDs, magneto-optical media such as floptical disks, or hardware devices such as ROMs, RAMs and flash memories, which are specially configured to store and execute program commands. Examples of the program commands include a machine language code created by a compiler and a high-level language code executable by a computer using an interpreter and the like.

While the present invention has been particularly shown and described with reference to exemplary embodiments thereof, it will be understood by those of ordinary skill in the art that various changes in form and details may be made therein without departing from the spirit and scope of the present invention as defined by the following claims.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

### INDUSTRIAL APPLICABILITY

The aforementioned energy management system of a sunlight/ESS device for tracking a generation reference and method of controlling the same may be applied to various fields. For example, the energy management system of a sunlight/ESS device for tracking a generation reference and method of controlling the same may be applied to an apparatus for saving energy.

1. An energy management system of a sunlight/energy storage system (ESS) device for tracking a generation reference, the energy management system comprising:
a sunlight generation unit for producing electric energy from sunlight;
a power converter for converting electric energy produced by the sunlight generation unit into alternating current (AC) power and outputting the AC power;
a PCS for receiving the AC power converted by the power converter, converting the AC power into direct current (DC) power, and outputting the DC power;
an ESS for receiving and storing the DC power converted by the PCS;
a Korea electric power system for buying the AC current converted through the PCS from the AC power converted by the power converter or the DC power stored in the ESS;
a load for receiving and using the AC power sold to the Korea electric power system; and
an energy management system (EMS) for receiving generation information of the sunlight generation unit, storage information of the ESS, and system information of the load, controlling power of the power converter and the PCS to control a charge amount of the ESS, and controlling a power amount sold to the Korea electric power system.

2. The energy management system of claim 1, wherein the EMS controls charging of the ESS, arbitrarily adjusts a selling time and a power amount of power sold to the one system, and simultaneously performs selling of power and charging of the ESS when a generation amount of the sunlight generation unit is higher than a reference generation amount.

3. The energy management system of claim 1, wherein the EMS determines optimization and calculation of charging of the ESS and a selling amount to the Korea electric power system according to Expression 1 below:
min{ω₁·C₁·P_{cap.loss}+ω₂·C₂·Pₛₑₗₗ+ω₃·(∫Pₑₓₚ−∫Pₑₛₛ)²} Expression 1
where Pₑₛₛ≤P_{gen}, and w₁ is a objective function weight 1, w₂ is an objective function weight 2, w₃ is an objective function weight 3, c₁ is a price of electric energy sold with a weight of 5, c₂ is a price of electric energy at first cost without a weight applied thereto, Pₑₓₚ is a power reference for charging power generated for six hours according to capacity of the ESS, P_{cap.loss} is a power loss occurring due to capacity efficiency, Pₛₑₗₗ is an amount of power sold without a weight, P_{gen} is a generated power amount, and Pₑₛₛ is a charged power amount of the ESS.

4. The energy management system of claim 3, wherein the power loss P_{cap.loss} due to capacity efficiency is represented according to Expression 2 below:
$${P}_{cap . loss} = {P}_{ess} \cdot ( 1 - {η}_{cap . loss} ) \\ {η}_{cap . loss} = - {κ ( \frac{{P}_{ess}}{{P}_{rate}} )}^{3} + 1 \qquad Expression 2$$
where the power loss P_{cap.loss} occurring due to capacity efficiency of the ESS (battery), indicating that the extend of loss is increased as power is increased as represented in Expression 2 above, is applied to η_{cap.loss} to change an inclination to k due to the different capacity characteristics for each battery of the ESS.

5. The energy management system of claim 3, wherein the EMS adjusts a charging amount of the ESS to appropriately distribute power for 6 hours during which power is applied, and uses (∫Pₑₓₚ−∫Pₑₛₛ)² with a weight applied thereto to distribute charged power depending on a climate condition.

6. A method of controlling an energy management system of a sunlight/energy storage system (ESS) device for tracking a generation reference, the method comprising:
recognizing generation information of a sunlight generation unit, charging information of an ESS, and system information of a load;
determining whether a current time is a charging time;
selling charged power of the ESS to Korea electric power system when the current time is not the charging time;
analyzing, optimizing, and calculating the generation information of the sunlight generation unit, the charging information of the ESS, and the system information of the load when the current time is the charging time;
determining whether a power selling amount sold without a weight via optimization and calculation is greater or smaller than a reference value via comparison therebetween;
selling a portion of power generated by the sunlight generation unit to the Korea electric power system and also charging the ESS when the power selling amount sold without a weight is greater than the reference value; and
charging generated power produced by the sunlight generation unit in the ESS when the power selling amount sold without a weight is less than the reference value.

7. The method of claim 6, wherein the EMS corrects a reference function for charging energy generated for six hours according to capacity of the ESS during generation of the sunlight generation unit to change a plan about charging of the ESS and power assignment of the Korea electric power system.

8. The method of claim 6, wherein the EMS determines optimization and calculation of charging of the ESS and a selling amount to the Korea electric power system according to Expression 1 below:
min{ω₁·C₁·P_{cap.loss}+ω₂·C₂·Pₛₑₗₗ+ω₃·(∫Pₑₓₚ−∫Pₑₛₛ)²} Expression 1
where Pₑₛₛ≤P_{gen}, and w₁ is a objective function weight 1, w₂ is an objective function weight 2, w₃ is an objective function weight 3, c₁ is a price of electric energy sold with a weight of 5, c₂ is a price of electric energy at first cost without a weight, Pₑₓₚ is a power reference for charging power generated for six hours according to capacity of the ESS, P_{cap.loss} is a power loss occurring due to capacity efficiency, Pₛₑₗₗ is an amount of power sold without a weight applied thereto, P_{gen} is a generated power amount, and Pₑₛₛ is a charged power amount of the ESS.
